(19) United States
(12) Patent Application Publication
(10) Pub. No.: US 2013/0188573 A1
(43) Pub. Date: Jul. 25, 2013

(54) RADIO COMMUNICATION APPARATUS AND RADIO COMMUNICATION METHOD

(71) Applicant: FUJITSU MOBILE COMMUNICATIONS LIMITED, Kawasaki-shi (JP)

(72) Inventor: Shinichiro SUZUKI, Hachioji (JP)

(73) Assignee: FUJITSU MOBILE COMMUNICATIONS LIMITED, Kawasaki-shi (JP)

(21) Appl. No.: 13/737,496

(22) Filed: Jan. 9, 2013

(30) Foreign Application Priority Data
Jan. 25, 2012 (JP) 2012-012735

(51) Int. Cl. H04W 88/06

(52) U.S. Cl. CPC H04W 88/06
USPC 370/329

(57) ABSTRACT

A radio communication apparatus includes a first access unit and a second access unit. The first access unit accesses a first radio network. The second access unit accesses a second radio network that performs higher-speed communication than the first radio network. When a packet connection request is made while the radio communication apparatus is in a service area of the first radio network, the second access unit accesses the second radio network, and attempts to make a connection to the second radio network.

### CROSS-REFERENCE TO RELATED APPLICATION

This application is based upon and claims the benefit of priority of the prior Japanese Patent Application No. 2012-012735, filed on Jan. 25, 2012, the entire contents of which are incorporated herein by reference.

### FIELD

The embodiments discussed herein relate to a radio communication apparatus and radio communication method that perform radio communication.

### BACKGROUND

Currently, as a next-generation high-speed radio communication technology, development of LTE (Long Term Evolution) has been advanced. The LTE has a wide bandwidth of a maximum of 20 MHz, and achieves a maximum of 300 Mbps in downlink and a maximum of 75 Mbps in uplink.

The LTE is a communication system specialized in packet communication, and aims at providing all services using IP (Internet Protocol) without using a conventional function of a CS (Circuit Switched) domain.

In an existing 3G (3^{rd} generation radio communication) network, both communication modes of the above-mentioned CS used for a voice call and PS (Packet Switched) used for data communication are provided. In contrast with this, the LTE includes only the PS, which achieves higher-speed packet communication than the PS of the 3G network.

Therefore, a voice call service having conventionally used the CS is replaced by a VoIP (Voice over IP) or the like. It is to be noted that the 3G network using the CS includes, for example, CDMA (Code Division Multiple Access) 20001x (it is called “1 x” since one (single-carrier) band of 1.25 MHz is used).

In addition, in order to replace all communication services including the voice call with the IP, in the LTE, a communication system called an IMS (IP Multimedia Subsystem) has been introduced in which all communication services also including services provided in the CS are integrated by a control protocol, such as a SIP (Session Initiation Protocol).

Meanwhile, there is a possibility that it takes time before construction of a VoIP service by the IMS is completed. Therefore, even though the VoIP service is not directly provided on the LTE, a technology called CS fallback has been proposed that provides a voice call service for a user using the conventional CS, and the technology is standardized by the 3GPP (3^{rd} Generation Partnership Project).

In operation of the CS fallback, for example, at the time of voice call arrival in a mobile terminal on standby in an LTE mode, the mobile terminal receives an incoming call signal from the LTE to switch the communication mode to the CS, and performs a voice call through the CS.

In addition, at the time of voice call origination from the mobile terminal, the mobile terminal makes a call origination request to the LTE, receives a handover command from the LTE to switch the communication mode to the CS, and makes a voice call through the CS.

As a conventional technology, a technology to search a base station of the LTE utilizing information on presence/absence of CS fallback has been proposed in Japanese Laid-open Patent Publication No. 2010-147576.

As described above, when the mobile terminal makes a voice call on the LTE, a function of the CS fallback works, the communication mode is switched from the LTE to the CS of the 3G network, and a voice call is performed once the mobile terminal is connected to the CS.

However, in the conventional technology, there was a case where the mobile terminal tried to make the communication mode return to high-speed packet communication of the LTE but failed to after the completion of the voice call, it was connected to a PS domain from a CS domain of the 3G network, and low-speed packet communication was performed.

As described above, in the conventional technology, there has been a problem that the mobile terminal may fall into a situation where only a low-speed data communication service is utilized in spite of being under an environment where a high-speed data communication service is available, and thereby high-speed packet communication is not performed, which causes degradation in a communication service.

### SUMMARY

According to an aspect of the embodiments, there is provided a radio communication apparatus. The radio communication apparatus includes: a first access unit that accesses a first radio network; and a second access unit that accesses a second radio network that performs higher-speed communication than the first radio network, wherein when a packet connection request is made while the radio communication apparatus is in a service area of the first radio network, the second access unit accesses the second radio network.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 illustrates a configuration example of a radio communication apparatus;

FIG. 2 illustrates a network configuration example;

FIG. 3 illustrates a hardware configuration example;

FIG. 4 illustrates a functional block configuration example;

FIG. 5 is a sequence diagram for describing reselection operation at the time of packet call origination from a UE;

FIG. 6 is a sequence diagram for describing reselection operation at the time of packet call origination from the UE;

FIG. 7 is a sequence diagram for describing reselection operation at the time of packet call origination from the UE;

FIG. 8 is a sequence diagram for describing reselection operation at the time of packet call origination from the UE;

FIG. 9 is a sequence diagram for describing reselection operation at the time of packet call origination from the UE;

FIG. 10 is a sequence diagram for describing reselection operation at the time of packet call origination from the UE;

FIG. 11 illustrates an operation flow of the UE;

FIG. 12 illustrates an operation flow of the UE; and

FIG. 13 illustrates an operation flow of the UE.

### DESCRIPTION OF EMBODIMENTS

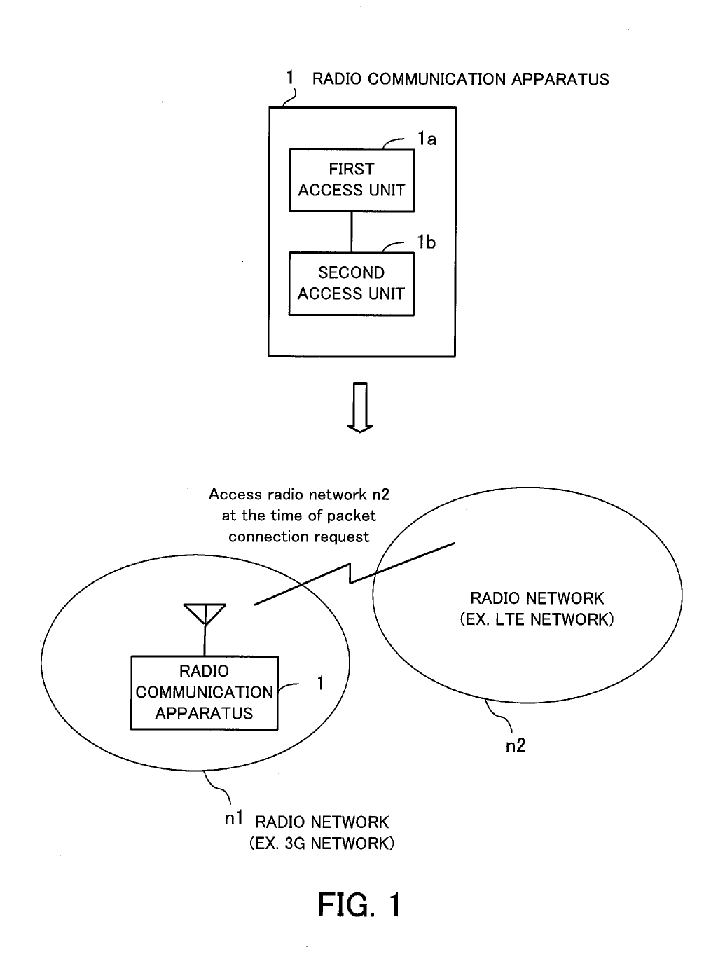

Several embodiments will be described below with reference to the accompanying drawings, wherein like reference numerals refer to like elements throughout. FIG. 1 illustrates a configuration example of a radio communication apparatus.

A radio communication apparatus 1 includes a first access unit 1a (referred to below as an access unit 1a) and a second access unit 1b (referred to below as an access unit 1b) and, for example, corresponds to a mobile terminal like a mobile phone.

The access unit 1a accesses a first radio network (a radio network n1). The access unit 1b accesses a second radio network (a radio network n2) that performs higher-speed communication than the radio network n1.

In addition, when a packet connection request is made while the radio communication apparatus 1 is in a service area of the radio network n1, the access unit 1b accesses the radio network n2, and attempts to make a connection to the radio network n2.

Here, a case is considered where a general mobile terminal that is able to enjoy a communication service of LTE moves near a boundary between an LTE network and a 3G network. As mentioned above, when a voice call is performed, the mobile terminal performs the voice call through the 3G network by CS fallback.

In addition, after the voice call is completed, the mobile terminal reconnects to a base station on the LTE side to perform control of re-updating location registration thereof (this control is called reselection).

When the mobile terminal fails in the reselection, for example, a timer in the mobile terminal is started, the mobile terminal performs reselection again at the time of expiration of the timer, and attempts to make a connection to the LTE. At this time, if the mobile terminal is present under the LTE network at the time of the expiration of the timer, there is a high possibility that the mobile terminal enters a state where it may communicate with the base station on the LTE side.

However, since the mobile terminal is located near the boundary between the LTE network and the 3G network, it may be present under the 3G network at the time of the expiration of the timer, and in this case, the mobile terminal belongs to a service area of the 3G network.

Additionally, assume that the mobile terminal moves near the boundary between the 3G network and the LTE network, and enters a state where it may be connected to the LTE network. In this case, when the mobile terminal receives a request for data communication from a user, it is connected to the 3G network because of being in the service area of the 3G network.

As described above, the conventional mobile terminal is connected to the 3G network in spite of being under an environment where a high-speed data communication service of the LTE is available, and the mobile terminal falls into a situation where only a low-speed data communication service is utilized, thus causing degradation of a communication service.

In contrast with this, the radio communication apparatus 1 is configured such that even when a packet connection request is made while the radio communication apparatus 1 is in the service area of the 3G network, the radio communication apparatus 1 performs forced access (forced reselection) to the LTE network, and attempts to make a connection to the LTE network.

As a result of this, when the high-speed communication service may be enjoyed, it becomes possible to avoid switching to the low-speed communication service, and to execute high-speed packet communication, thus allowing the communication service to be improved.

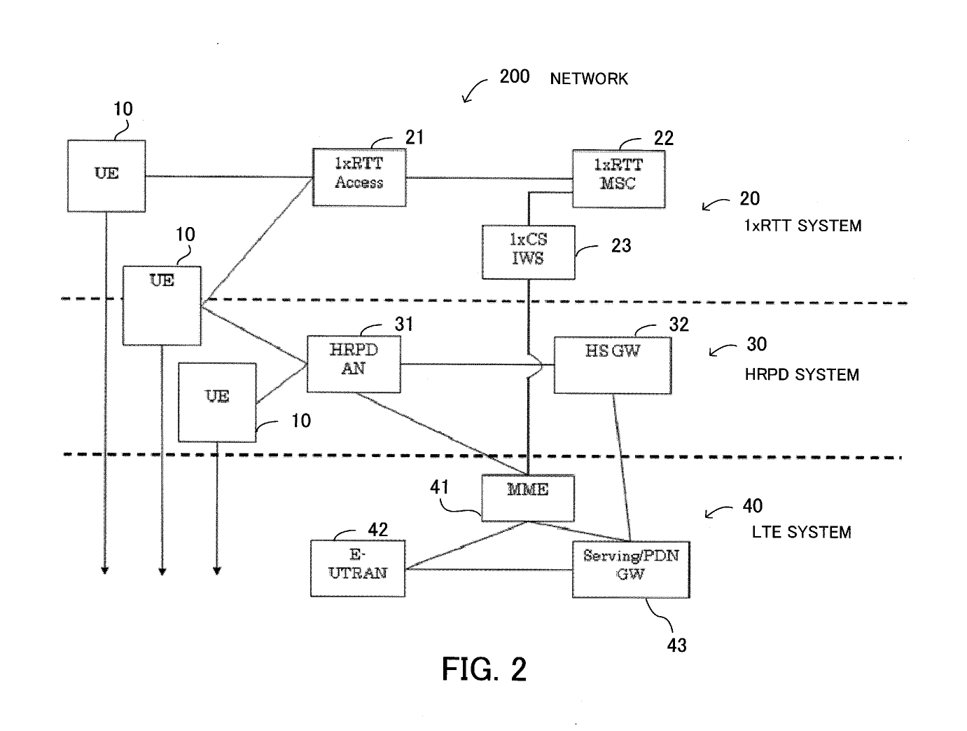

Next, a network configuration will be described. FIG. 2 illustrates a network configuration example. A network 200 includes: a 1xRTT (1x Radio Transmission Technology) system 20; an HRPD (High Rate Packet Data) system 30; and an LTE system 40.

The 1xRTT system 20 is one of technical specifications included in a CDMA2000 standard that is a mobile phone system in which a CDMA technology is applied, and constitutes a CDMA20001x network.

The HRPD system 30 constitutes a CDMA2000 HRPD network in which higher-speed communication than in the 1xRTT system 20 may be performed. The LTE system 40 constitutes an LTE network in which further higher-speed communication than in the HRPD system 30 may be performed.

The 1xRTT system 20 includes: 1xRTT Access 21; a 1xRTT MSC (Mobile Switching Center) 22; and a 1xCS IWS (Circuit Switched Interworking Solution) 23.

The 1xRTT Access21 is a CDMA20001x access network, and becomes a radio destination when a UE (User Equipment: mobile terminal) 10 is in a service area of the CDMA20001x network.

The 1xRTT MSC22 performs 1x signaling processing of the 1xRTT system 20. The 1xCS IWS23 serves as a relay unit for tunneling a 1x signaling message in performing CS fallback processing between the 1xRTT system 20 and the LTE system 40.

The HRPD system 30 includes an HRPD AN (Access Network) 31 and an HS GW (HRPD Serving Gateway) 32.

The HRPD AN31 is a CDMA2000 HRPD access network, and becomes a radio destination when the UE10 is in a service area of the HRPD system 30. The HS GW32 is a gateway that links between the HRPD system 30 and the LTE system 40, and performs user data processing in the HRPD system 30.

The LTE system 40 includes: an MME (Mobility Management Entity) 41; an E-UTRAN (Evolved Universal Terrestrial Radio Access Network) 42; and a Serving/PDN GW (Packet Data Network Gateway) 43.

The MME41 performs LTE signaling processing of the LTE system 40. The E-UTRAN42 is an E-UTRAN access network, and becomes a radio destination when the UE10 is in a service area of the LTE system 40. The Serving/PDN GW43 performs user data processing of the LTE system 40.

It is to be noted that as a connection relation of each component in the network 200, the 1xRTT Access21 is connected to the 1xRTT MSC22. The 1xCS IWS23 is connected to the 1xRTT MSC22 and MME41.

The MME41 is connected to the 1xCS IWS23, HRPD AN31, E-UTRAN42, and Serving/PDN GW43. In addition, the E-UTRAN42 and Serving/PDN GW43 are connected to each other.

The HRPD AN31 is connected to the HS GW32 and MME41, and the HS GW32 is connected to the HRPD AN31 and Serving/PDN GW43.

In the network 200 as described above, FIG. 2 illustrates a state where as a destination, the UE10 moves from the 1xRTT system 20 or HRPD system 30 that is a low-speed communication system to the LTE system 40 that is a high-speed communication system to be spread in the future. It is to be noted that in the connection state illustrated in FIG. 2, the UE10 is connected to the 1xRTT Access21 or HRPD AN31.

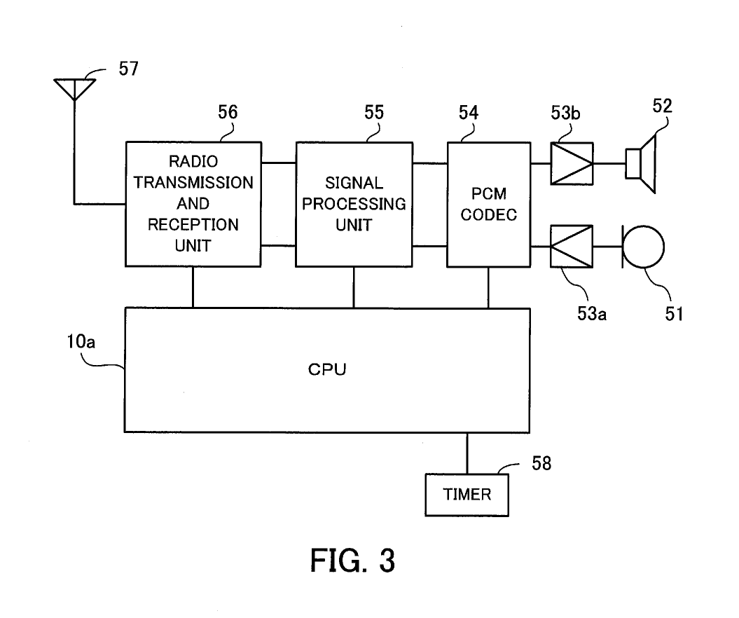

Next, a hardware configuration of a UE corresponding to the radio communication apparatus 1 will be described. FIG. 3 illustrates a hardware configuration example. The UE10 includes: a CPU (Central Processing Unit) 10a; a microphone 51; a speaker 52; amplifiers 53a and 53b; a PCM (Pulse Code Modulation) codec 54; a signal processing unit 55; a radio transmission and reception unit 56; an antenna 57; and a timer 58.

In transmission processing, a voice input from the microphone 51 is amplified by the amplifier 53a. The PCM codec 54 performs coding processing of an amplified voice signal. The signal processing unit 55 converts into an analog signal a digital signal obtained by coding the voice. The radio transmission and reception unit 56 performs transmission on the radio through the antenna 57 to the 1xRTT Access21, HRPD AN31, and E-UTRAN42 that are radio base stations. A radio frequency signal is transmitted to a radio base station through the antenna 57.

In reception processing, a signal received through the antenna 57 is converted into an analog signal by the radio transmission and reception unit 56. The signal processing unit 55 converts the analog signal into a digital signal. The PCM codec 54 performs decoding processing of a digital voice signal. The amplifier 53b amplifies the decoded voice signal. The amplified voice signal is output from the speaker 52.

It is to be noted that a CPU10a performs whole control of each component and communication control over the above-described transmission and reception processing. In addition, when the timer 58 measures time for a certain period to reach expiration thereof, it transmits an interrupt signal to the CPU10a. The CPU10a that has received the interrupt signal performs predetermined interrupt processing.

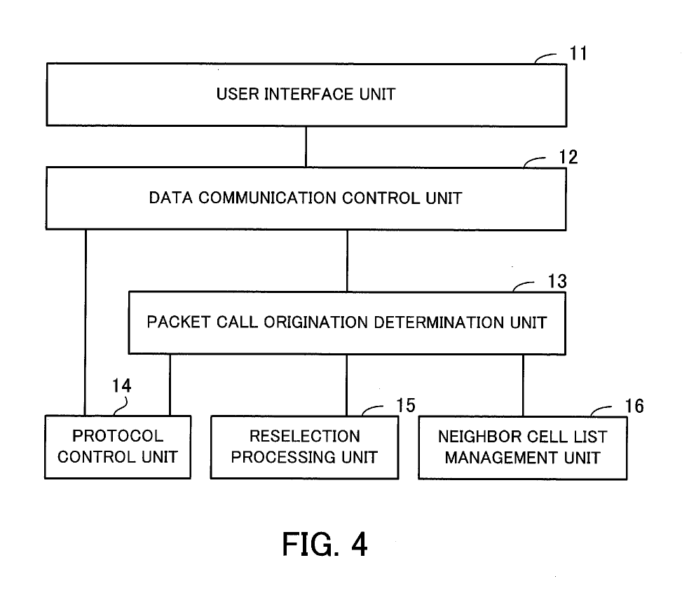

Next, a functional block of the UE10 related to the technology will be described. FIG. 4 illustrates a functional block configuration example. The UE10 includes: a user interface unit 11; a data communication control unit 12; a packet call origination determination unit 13; a protocol control unit 14; a reselection processing unit 15; and a neighbor cell list management unit 16. It is to be noted that operation of each component may be executed by the CPU10a.

The user interface unit 11 performs user interface processing, such as voice input and output with the user, and manipulation and display control. The data communication control unit 12 performs data communication call connection control and data transmission and reception control. The packet call origination determination unit 13 decides a currently serving network, and determines whether to make a packet call origination.

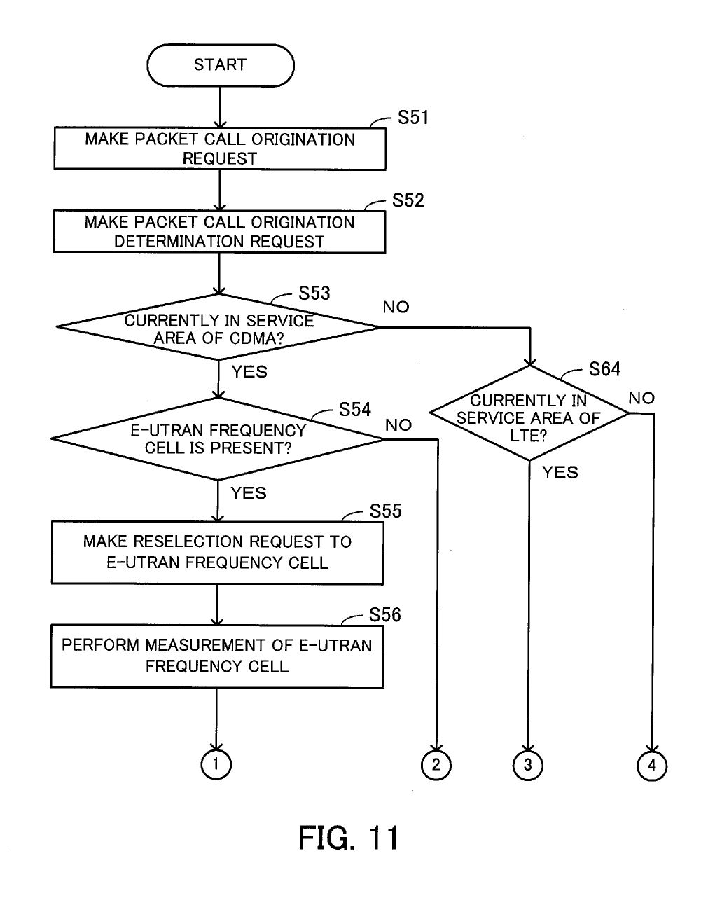

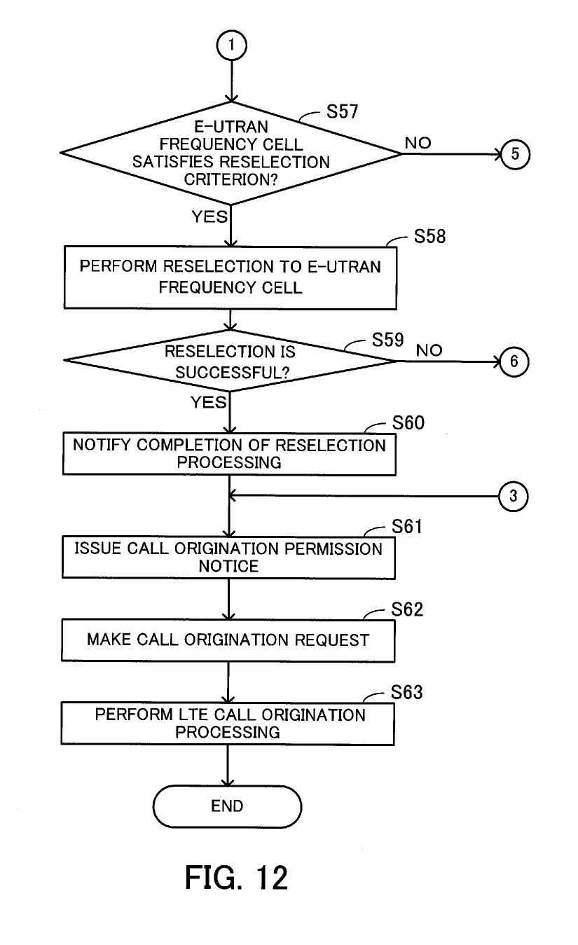

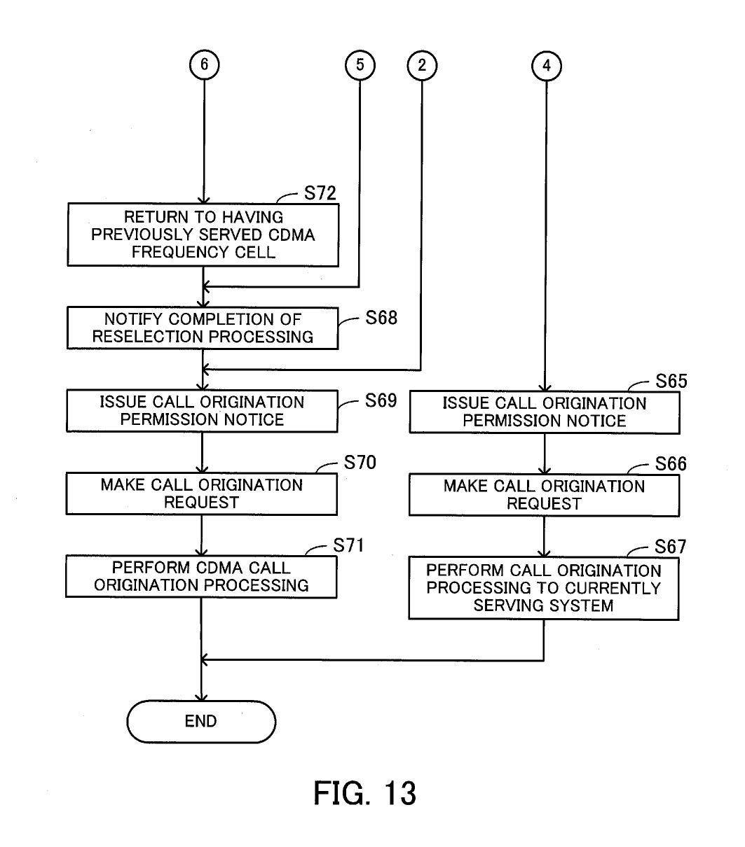

The protocol control unit 14 performs packet call origination processing corresponding to each communication protocol. The reselection processing unit 15 has functions of the access units 1a and 1b illustrated in FIG. 1, and performs reselection processing. The neighbor cell list management unit 16 stores and manages frequency channel information on a neighbor cell (peripheral cell of a connected cell). It is to be noted that detailed operation will be mentioned later using operation flows of FIGS. 11 to 13.

Next, reselection operation of the UE10 will be described below while comparing conventional reselection operation and reselection (forced reselection) operation of the technology.

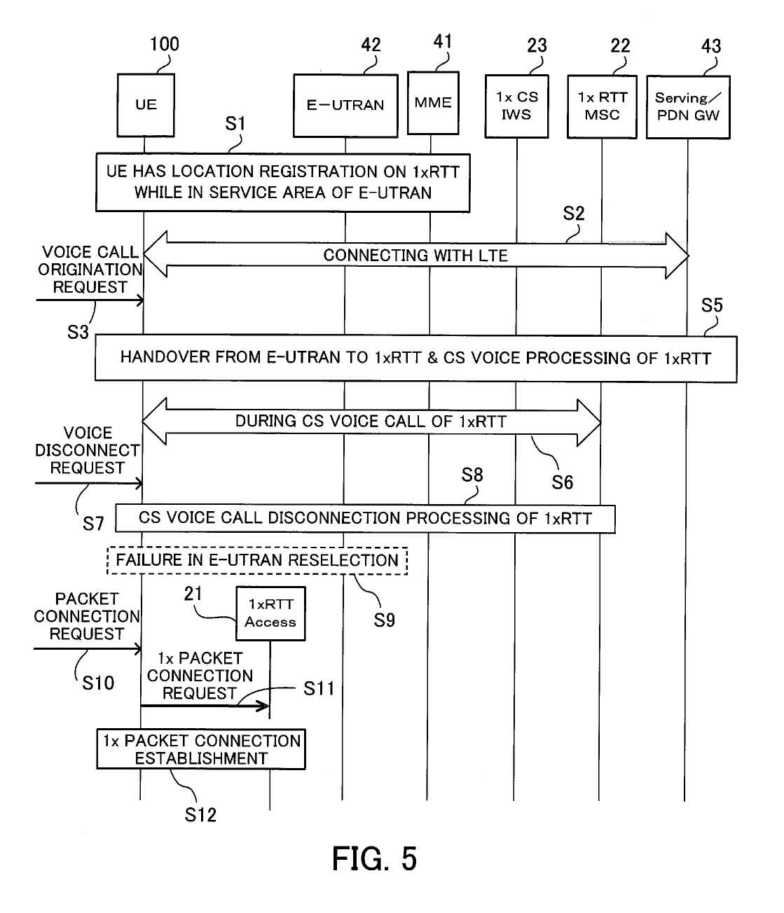

First, will be described reselection operation at the time of packet call origination after handover is performed from the LTE to the 1xRTT. FIG. 5 is a sequence diagram for describing reselection operation at the time of packet call origination from the UE. FIG. 5 illustrates conventional reselection operation at the time of packet call origination after handover is performed from the LTE to the 1xRTT.

[S1] A UE100 makes a location registration request to the E-UTRAN42, and the MME41 performs signaling processing of the UE100. As a result of this, the UE100 belongs to a service area of the E-UTRAN42.

Subsequently, the UE100 makes a location registration request to the 1xRTT. In this case, the 1x signaling message in performing CS fallback processing is tunneled from the MME41 to the 1x RTT MSC22 through the 1x CS IWS23. Signaling processing of the UE100 is then performed by the 1x RTT MSC22.

[S2] User data processing of user data from the UE100 is performed in the Serving/PDN GW43. The UE100 enters a connection state to the LTE.

[S3] The UE100 receives a voice call origination request from a user.

[S5] Handover processing from the E-UTRAN42 to the 1xRTT is executed. Further, CS voice call establishment processing is performed by the 1xRTT.

[S6] The UE100 performs a voice call using CS of the 1xRTT.

[S7] The UE100 receives a voice call disconnection request from the user.

[S8] The 1xRTT performs CS voice call disconnection processing.

[S9] Assume that the UE100 tries to perform reselection to the E-UTRAN42 in order to return to the E-UTRAN42 after the completion of the voice call, but fails to do so. In this case, the UE100 remains in the 1xRTT.

[S10] The UE100 receives a packet connection request from the user.

[S11] The UE100 makes a 1x packet connection request to the 1x 1xRTT Access21.

[S12] Packet connection is established between the UE100 and the 1xRTT Access21.

As described above, in a conventional sequence, even though there is a probability of connecting to the E-UTRAN (utilizing LTE packet communication) at the time of the packet connection request, packet call origination is made to the currently serving 1xRTT.

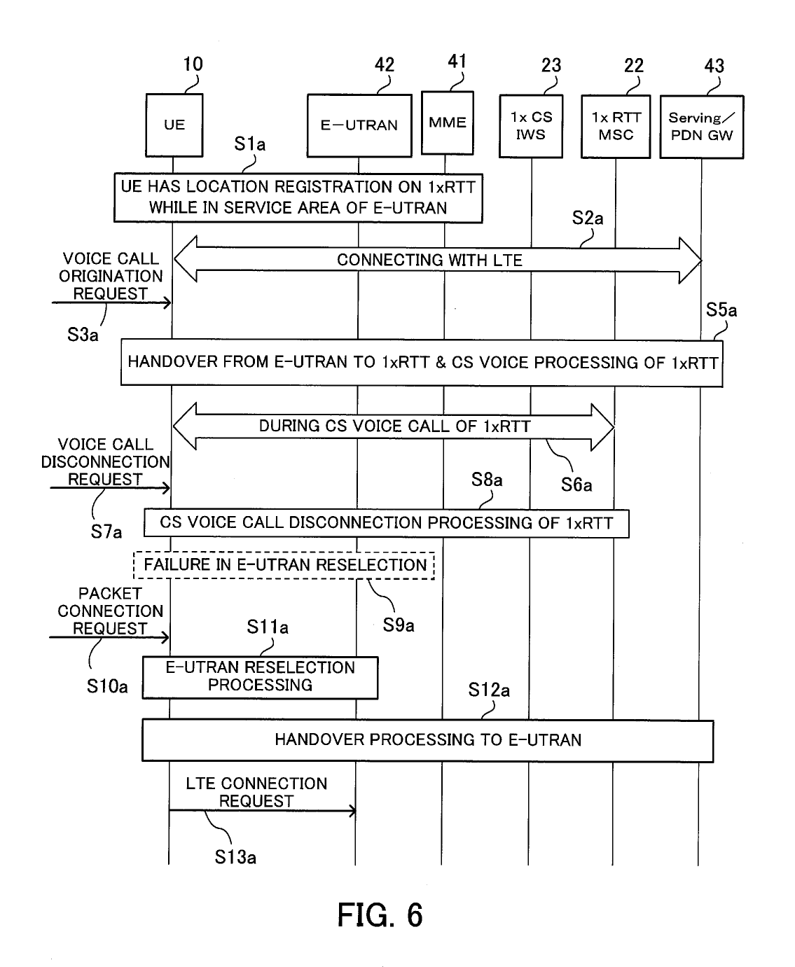

FIG. 6 is a sequence diagram for describing reselection operation at the time of packet call origination from the UE. FIG. 6 illustrates forced reselection operation of the technology at the time of packet call origination after handover is performed from the LTE to the 1xRTT.

[S1a] The UE10 makes the location registration request to the E-UTRAN42, and the MME41 performs signaling processing of the UE10. As a result of this, the UE10 belongs to the service area of the E-UTRAN42.

Subsequently, the UE10 makes a location registration request to the 1xRTT. In this case, the 1x signaling message in performing CS fallback processing is tunneled from the MME41 to the 1x RTT MSC22 through the 1x CS IWS23. Signaling processing of the UE10 is then performed by the 1x RTT MSC22.

[S2a] User data processing of user data from the UE10 is performed in the Serving/PDN GW43. The UE10 enters a connection state to the LTE.

[S3a] The UE10 receives a voice call origination request from the user.

[S5a] Handover processing from the E-UTRAN42 to the 1xRTT is executed. Further, CS voice call establishment processing is performed by the 1xRTT.

[S6a] The UE10 performs a voice call using the CS of the 1xRTT.

[S7a] The UE10 receives a voice call disconnection request from the user.

[S8a] The 1xRTT performs CS voice call disconnection processing.

[S9a] Assume that the UE10 tries to perform reselection to the E-UTRAN42 in order to return to the E-UTRAN42 after the completion of the voice call, but fails to do so. In this case, the UE10 remains in the 1xRTT.

[S10a] The UE10 receives a packet connection request from the user.

[S11a] The UE10 executes forced reselection processing to the E-UTRAN42 in order to return to the E-UTRAN42.

[S12a] Handover processing from the 1xRTT to the E-UTRAN42 is performed.

[S13a] The UE10 makes an LTE connection request to the E-UTRAN42.

As described above, the UE10 holds the packet connection request to the currently serving 1xRTT at the time of the packet connection request, and performs forced reselection to the E-UTRAN42 in the meantime. When the reselection is successful, LTE connection is performed to the E-UTRAN42.

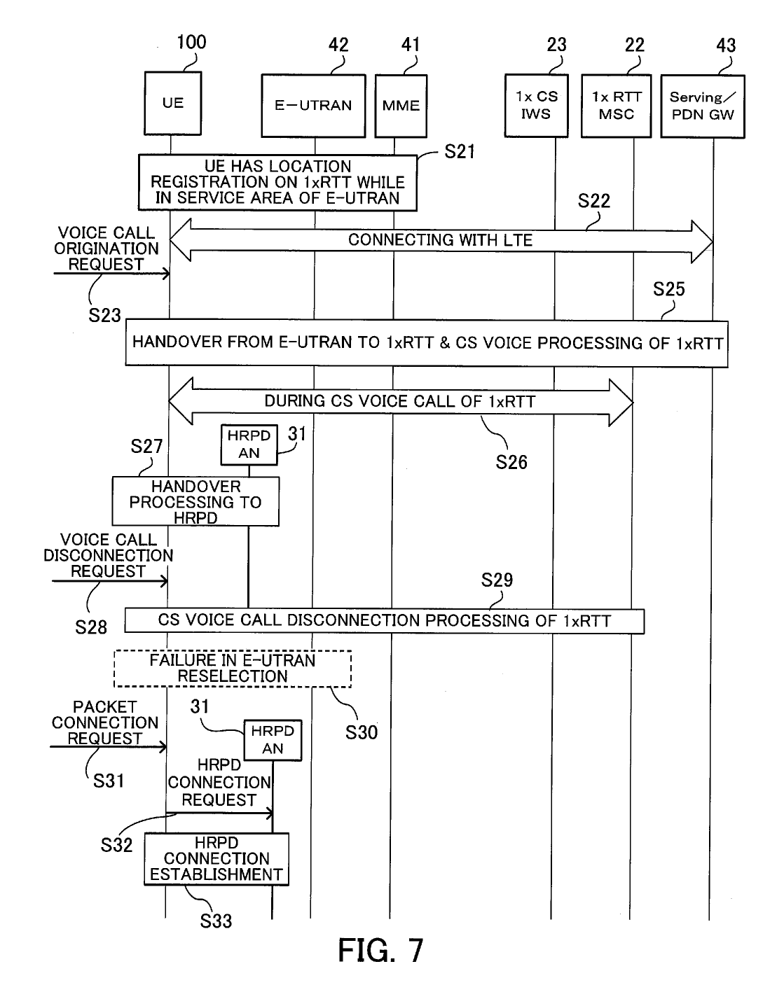

Next, will be described reselection operation at the time of packet call origination after handover is performed from the LTE to the 1xRTT and HRPD. FIG. 7 is a sequence diagram for describing reselection operation at the time of packet call origination from the UE. FIG. 7 illustrates conventional reselection operation at the time of packet call origination after handover is performed from the LTE to the 1xRTT and HRPD.

[S21] The UE100 makes a location registration request to the E-UTRAN42, and the MME41 performs signaling processing of the UE100. As a result of this, the UE100 belongs to the service area of the E-UTRAN42.

Subsequently, the UE100 makes the location registration request to the 1xRTT. In this case, the 1x signaling message in performing the CS fallback processing is tunneled from the MME41 to the 1x RTT MSC22 through the 1x CS IWS23. Signaling processing of the UE100 is then performed by the 1x RTT MSC22.

[S22] User data processing of user data from the UE100 is performed in the Serving/PDN GW43. The UE100 enters a connection state to the LTE.

[S23] The UE100 receives a voice call origination request from the user.

[S25] Handover processing from the E-UTRAN42 to the 1xRTT is executed. Further, CS voice call establishment processing is performed by the 1xRTT.

[S26] The UE100 performs a voice call using the CS of the 1xRTT.

[S27] The UE100 performs, to the HRPD AN31, handover processing to the HRPD.

[S28] The UE100 receives a voice call disconnection request from the user.

[S29] The 1xRTT performs CS voice call disconnection processing.

[S30] Assume that the UE100 tries to perform reselection to the E-UTRAN42 in order to return to the E-UTRAN42 after the completion of the voice call, but fails to do so. In this case, the UE100 remains in the 1xRTT and HRPD.

[S31] The UE100 receives a packet connection request from the user.

[S32] The UE100 makes an HRPD packet connection request to the HRPD AN31.

[S33] Packet connection is established between the UE100 and HRPD.

As described above, in the conventional sequence even though there is a probability of connecting to the E-UTRAN42 (utilizing LTE packet communication) at the time of the packet connection request, HRPD connection is performed to the currently serving HRPD.

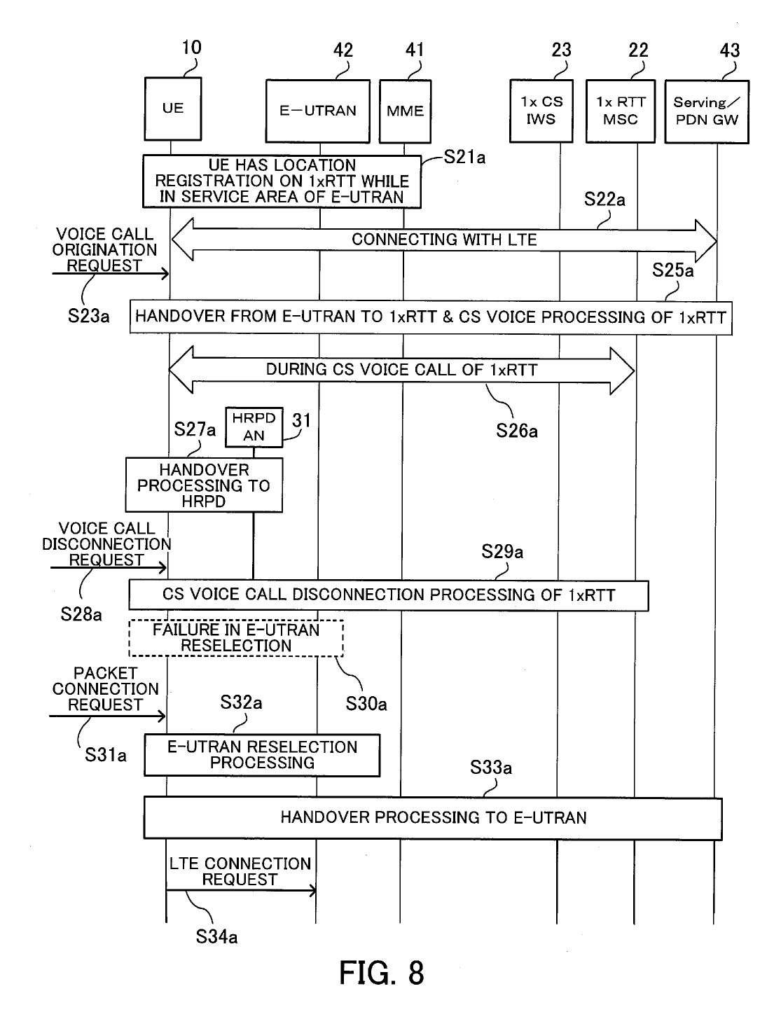

FIG. 8 is a sequence diagram for describing reselection operation at the time of packet call origination from the UE. FIG. 8 illustrates forced reselection operation of the technology at the time of packet call origination after handover is performed from the LTE to the 1xRTT and HRPD.

[S21a] The UE10 makes a location registration request to the E-UTRAN42, and the MME41 performs signaling processing of the UE10. As a result of this, the UE10 belongs to the service area of the E-UTRAN42.

Subsequently, the UE10 makes a location registration request to the 1xRTT. In this case, the 1x signaling message in performing the CS fallback processing is tunneled from the MME41 to the 1x RTT MSC22 through the 1x CS IWS23. Signaling processing of the UE10 is then performed by the 1x RTT MSC22.

[S22a] User data processing of user data from the UE10 is performed in the Serving/PDN GW43. The UE10 enters a connection state to the LTE.

[S23a] The UE10 receives a voice call origination request from the user.

[S25a] Handover processing from the E-UTRAN42 to the 1xRTT is executed. Further, CS voice call establishment processing is performed by the 1xRTT.

[S26a] The UE10 performs a voice call using the CS of the 1xRTT.

[S27a] The UE10 performs, to the HRPD AN31, handover processing to the HRPD.

[S28a] The UE10 receives a voice call disconnection request from the user.

[S29a] The 1xRTT performs CS voice call disconnection processing.

[S30a] Assume that the UE10 tries to perform reselection to the E-UTRAN42 in order to return to the E-UTRAN42 after the completion of the voice call, but fails to do so. In this case, the UE10 remains in the 1xRTT and HRPD.

[S31a] The UE10 receives a packet connection request from the user.

[S32a] The UE10 executes forced reselection processing to the E-UTRAN42 in order to return to the E-UTRAN42.

[S33a] Handover processing from the 1xRTT to the E-UTRAN42 is performed.

[S34a] The UE10 makes an LTE connection request to the E-UTRAN42.

As described above, the UE10 holds the packet connection request to the currently serving 1xRTT at the time of the packet connection request, and performs forced reselection to the E-UTRAN42 in the meantime. When the reselection is successful, LTE connection is performed to the E-UTRAN42.

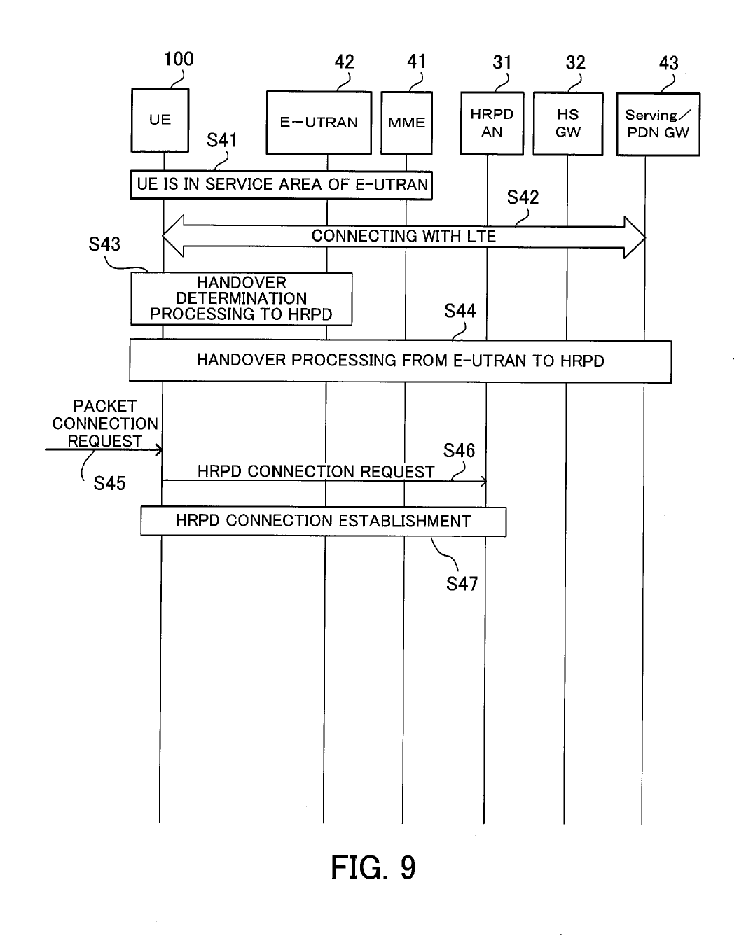

Next, will be described reselection operation at the time of packet call origination after handover is performed from the LTE to the HRPD. FIG. 9 is a sequence diagram for describing reselection operation at the time of packet call origination from the UE. FIG. 9 illustrates conventional reselection operation at the time of packet call origination after handover is performed from the LTE to the HRPD.

[S41] The UE100 makes a location registration request to the E-UTRAN42, and the MME41 performs the signaling processing of the UE100. As a result of this, the UE100 belongs to the service area of the E-UTRAN42.

[S42] User data processing of user data from the UE100 is performed in the Serving/PDN GW43. The UE100 enters a connection state to the LTE.

[S43] The UE100 performs handover determination processing to the HRPD.

[S44] Handover processing from the E-UTRAN42 to the HRPD is performed.

[S45] The UE100 receives a packet connection request from the user.

[S46] The UE100 makes an HRPD packet connection request to the HRPD AN31.

[S47] Packet connection is established between the UE100 and HRPD.

As described above, in the conventional sequence even though there is a probability of connecting to the E-UTRAN42 (utilizing LTE packet communication) at the time of the packet connection request, HRPD connection is performed to the currently serving HRPD.

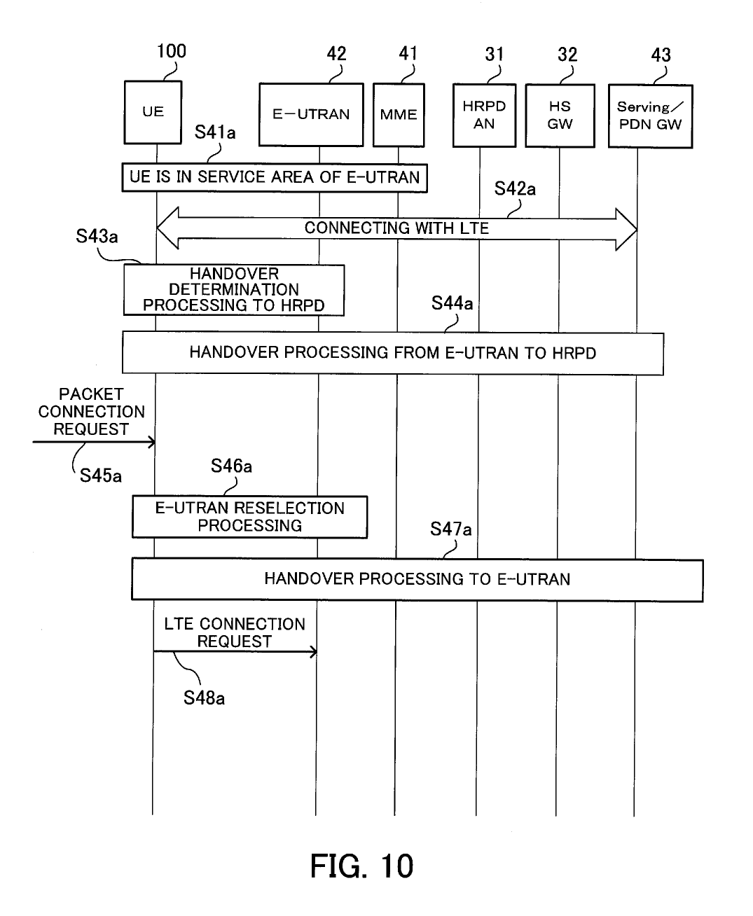

FIG. 10 is a sequence diagram for describing reselection operation at the time of packet call origination from the UE. FIG. 10 illustrates forced reselection operation of the technology at the time of packet call origination after handover is performed from the LTE to the HRPD.

[S41a] The UE100 makes a location registration request to the E-UTRAN42, and the MME41 performs signaling processing of the UE100. As a result of this, the UE100 belongs to the service area of the E-UTRAN42.

[S42a] User data processing of user data from the UE100 is performed in the Serving/PDN GW43. The UE100 enters a connection state to the LTE.

[S43a] The UE100 performs handover determination processing to the HRPD.

[S44a] Handover processing from the E-UTRAN42 to the HRPD is performed.

[S45a] The UE100 receives a packet connection request from the user.

[S46a] The UE100 executes forced reselection processing to the E-UTRAN42 in order to return to the E-UTRAN42.

[S47a] Handover processing from the 1xRTT to the E-UTRAN42 is performed.

[S48a] The UE100 makes an LTE connection request to the E-UTRAN42.

As described above, the UE100 holds the packet connection request to the currently serving HRPD at the time of the packet connection request, and performs forced reselection to the E-UTRAN42 in the meantime. When the reselection is successful, LTE connection is performed to the E-UTRAN42.

Next, operation of the UE10 will be described using flow charts. FIGS. 11 to 13 illustrate operation flows of the UE.

[S51] The user interface unit 11 makes a packet call origination request to the data communication control unit 12.

[S52] The data communication control unit 12 makes a call origination determination request to the packet call origination determination unit 13, before making a call origination request to the protocol control unit 14.

[S53] The packet call origination determination unit 13 inquires of the protocol control unit 14 about a currently serving system.

Namely, the packet call origination determination unit 13 inquires of the protocol control unit 14 whether or not the currently serving system is the CDMA (1xRTT or HRPD). If the currently serving system is the CDMA, the program proceeds to step S54. Otherwise the program proceeds to step S64.

[S54] The packet call origination determination unit 13 inquires of the neighbor cell list management unit 16 whether or not an E-UTRAN frequency cell (channel) is present in a neighbor cell list received from a network side.

If the E-UTRAN frequency cell (channel) is present in the neighbor cell list, the program proceeds to step S55, and if not present, the program proceeds to step S69.

[S55] The packet call origination determination unit 13 makes to the reselection processing unit 15 a reselection request of the E-UTRAN frequency cell on the neighbor cell list.

[S56] The reselection processing unit 15 performs measurement (measurement processing of various parameters indicating whether to actually perform communication in a good state) of the E-UTRAN frequency cell on the neighbor cell list.

[S57] The reselection processing unit 15 evaluates a measurement result of the E-UTRAN frequency cell on the neighbor cell list. In this case, the reselection processing unit 15 decides whether or not the E-UTRAN frequency cell satisfies a reselection criterion. If the E-UTRAN frequency cell satisfies the reselection criterion, the program proceeds to step S58, and if it does not satisfy, the program proceeds to step S68.

[S58] The reselection processing unit 15 performs reselection of the E-UTRAN frequency cell.

[S59] The reselection processing unit 15 decides whether or not it has succeeded in the reselection. If it has succeeded, the program proceeds to step S60, and if it has not been succeeded, the program proceeds to step S72.

[S60] The reselection processing unit 15 notifies the packet call origination determination unit 13 of completion of the processing.

[S61] The packet call origination determination unit 13 issues a call origination permission notice to the data communication control unit 12.

[S62] The data communication control unit 12 makes a call origination request to the protocol control unit 14.

[S63] The protocol control unit 14 performs LTE call origination processing.

[S64] The packet call origination determination unit 13 inquires of the protocol control unit 14 whether or not the currently serving system is the LTE. If the currently serving system is the LTE, the program proceeds to step S61. Otherwise the program proceeds to step S65.

[S65] The packet call origination determination unit 13 issues a call origination permission notice to the data communication control unit 12.

[S66] The data communication control unit 12 makes a call origination request to the protocol control unit 14.

[S67] The protocol control unit 14 performs call origination processing to the currently serving system.

[S68] The reselection processing unit 15 notifies the packet call origination determination unit 13 of completion of the reselection processing.

[S69] The packet call origination determination unit 13 issues a call origination permission notice to the data communication control unit 12.

[S70] The data communication control unit 12 makes a call origination request to the protocol control unit 14.

[S71] The protocol control unit 14 performs call origination processing to the CDMA (1xRTT or HRPD).

[S72] The reselection processing unit 15 returns to the having previously served CDMA frequency cell. The program proceeds to step S68.

As described above, the radio communication apparatus 1 is configured such that when the packet connection request from a communication application is generated in a state of being in the service area other than the E-UTRAN, the radio communication apparatus 1 holds the packet connection request, performs forced reselection to the E-UTRAN in the meantime, and restarts the packet connection request to the E-UTRAN.

As a result of this, a situation undesirable for a user is avoidable where only a low-speed data communication service is utilized in spite of being under an environment where a high-speed data communication service is available, thus allowing a communication service to be improved by executing high-speed packet communication.

It becomes possible to perform the high-speed packet communication.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that various changes, substitutions, and alterations could be made hereto without departing from the spirit and scope of the invention.

What is claimed is:

1. A radio communication apparatus comprising:
a first access unit that accesses a first radio network;
a second access unit that accesses a second radio network that performs higher-speed communication than the first radio network, wherein
when a packet connection request is made while the radio communication apparatus is located in a service area of the first radio network, the second access unit accesses the second radio network.

2. The radio communication apparatus according to claim 1, wherein, at the time of the packet connection request, the first access unit holds the packet connection request to the currently serving first radio network, and the second access unit forcibly accesses the second radio network.

3. The radio communication apparatus according to claim 1, wherein
when a voice call origination request is made while the radio communication apparatus is in a service area of the second radio network, the first access unit accesses the first radio network, and makes a voice call through circuit switching of the first radio network, and the second access unit accesses the second radio network at the time of the packet connection request after the voice call is disconnected.

4. A radio communication method, wherein
when a voice call origination request is made while a radio communication apparatus is connected to a second radio network that performs higher-speed communication than a first radio network,
the radio communication apparatus accesses the first radio network, and makes a voice call through circuit switching of the first radio network, and wherein
when a packet connection request is made after the voice call is disconnected,
the radio communication apparatus holds the packet connection request to the first radio network, and forcibly accesses the second radio network.
